(19) United States
(12) Patent Application Publication
(10) Pub. No.: US 2013/0275190 A1
(43) Pub. Date: Oct. 17, 2013

(54) METHOD OF PROVIDING REAL-TIME MOBILE SUPPLIER-TO-CUSTOMER COMMUNICATIONS AND TRANSACTIONS AND CORRESPONDING SYSTEM ARCHITECTURE

(71) Applicants: Marco Carlo Rossi, Grand Lancy (CH); Maurizio Micale, Le Grand Saconnex (CH)

(72) Inventors: Marco Carlo Rossi, Grand Lancy (CH); Maurizio Micale, Le Grand Saconnex (CH)

(73) Assignee: TAKEALL SA, Plan-Les-Ouates (CH)

(21) Appl. No.: 13/448,198

(22) Filed: Apr. 16, 2012

(51) Int. Cl. G06Q 30/06; G06Q 30/02

(52) U.S. Cl. 705/14.4; 705/27.1; 705/26.1

(57) ABSTRACT

A method provides real-time mobile supplier-to-customer communications and transactions based on client and business applications installed onto respective client user equipment and business user equipment. The method includes: starting a business query by the client application based on geolocalization of the client user equipment; inserting a business query by a customer through the client application; sending the business query criteria to a central server to establish a query result including suppliers meeting the business query criteria; sending the query result to the client application; selecting a supplier by the customer through the client application; sending business transaction data to the central server which pushes the business transaction data to the business application; and receiving an immediate reply from the business application toward the central server which pushes the reply to the client application, to allow the business transactions to be immediately confirmed, denied or changed.

### BACKGROUND

1. Technical Field

The present disclosure relates to a method of providing real-time mobile supplier-to-customer communications and transactions based on user-specific applications being in connection with a central server and to the corresponding communication system architecture.

2. Description of the Related Art

As is well known, different web sites currently provide an easy way to find services, shops and retailers of any kind, particularly by using proximity tools based on geo-localization in order to list the results of a user request in an order corresponding to the distance from the user itself.

Recently, many mobile applications have been also developed that allow a customer, which has downloaded and installed the corresponding application on a mobile equipment, such as a smart phone or a tablet, to find a service, a good or a shop nearby his/her current position and also nearby another selected position.

Mobile applications of this kind are constantly increasing due to the large diffusion of the Internet connections through land lines, WiFi systems and mobile standards.

The known web sites and mobile applications allow, for instance, to book a service, buy a product, or make promotion and deals though, in a general manner to execute a business transaction. However, very few sites and application provide a direct connection between the customer and the supplier. In particular, such direct connections usually take advantage of traditional communication methods such as direct phone calls, multimedia or text messaging such as SMS and MMS or phone calls, usually managed by call centers. In some cases, messages could be used, such messages being based on applications and specifically user interfaces that are identical for the customers and the suppliers, usually not related to the specific business needs of the suppliers themselves.

It should be thus remarked that all those known methods are inefficient, costly and time consuming.

In particular, in case of phone calls to be made by the user to the supplier, they interrupt the supplier staff during the normal work. Moreover, the customer has often to wait. On the other end, in case of a SMS-based connection, the simple textual messages could be too poor in content. Also MMS messages have some disadvantages, being not user-friendly, expensive, not easy to use and not providing specific functions being specifically adapted to the business needs of each customer. Finally, messaging should be based on a same communication application and platform that should be concurrently used both from the customer and the supplier, also interrupting the supplier staff during the normal work. Moreover, also in this case, no adaptation for the specific needs of the supplier and also of the customer is usually provided.

### BRIEF SUMMARY

An embodiment of this disclosure is directed to a business method allowing a business transaction, such as booking a service or buying a good, between a customer or client user and a supplier or business user both provided with a mobile application running on a respective mobile equipment, such as a smart phone or a tablet, and connected to a central server that manages the exchange of the messages back and forth from the client and business users, enabling an instantaneous setting of the business transaction, in this way overcoming the limits which still affect the methods realized according to the prior art.

The method of providing real-time supplier-to-customer communications and transactions based on a client application and a business application being installed onto respective client user equipment and business user equipment and in connection with a central server, the method comprising the steps of:
launching a client application of the client user equipment;
starting a business query by the client application by default based on geolocalization of the client user equipment;
inserting a business query by a customer through the client application;
sending the business query criteria to the central server in order to establish a query result including the suppliers meeting the business query criteria;
sending the query result to the client application in order to show it onto the client user equipment;
selecting a supplier by the customer through the client application;
providing business transaction data being duly formatted;
sending the business transaction data to the central server which pushes the business transaction data to the business application; and
receiving an immediate reply from the business application toward the central server which pushed the reply to the client application, so as to allow the business transactions to be immediately confirmed, denied or changed.

The communication system architecture comprises:
a client user equipment provided with a client application;
a business user equipment provided with a business application; and
a central server connected to the client user equipment and to the business user equipment through the corresponding client application and business application, respectively,
the client application and the business application being different from one another, each one providing user-specific functions and communicating via formatted information; the communication being in particular enabled by a server software in the central server providing both real time and deferred data transfers in order to send a business transaction request by the client application and receive an immediate reply from the business application about the business transaction being confirmed, denied or changed.

The characteristics and advantages of the business method and of the communication system architecture according to the disclosure will be apparent from the following description of embodiments thereof given by way of indicative and non-limiting example with reference to the annexed drawings.

### BRIEF DESCRIPTION OF THE SEVERAL VIEWS OF THE DRAWINGS

FIG. 1 schematically shows a communication system architecture according to an embodiment of the disclosure;

FIGS. 2, 3, 4A, 4B, 5A and 5B schematically show respective pages of a client application according to an embodiment of the disclosure; and

FIGS. 6, 7, 8, 9 and 10 schematically show respective pages of a business application according to an embodiment of the disclosure.

### DETAILED DESCRIPTION

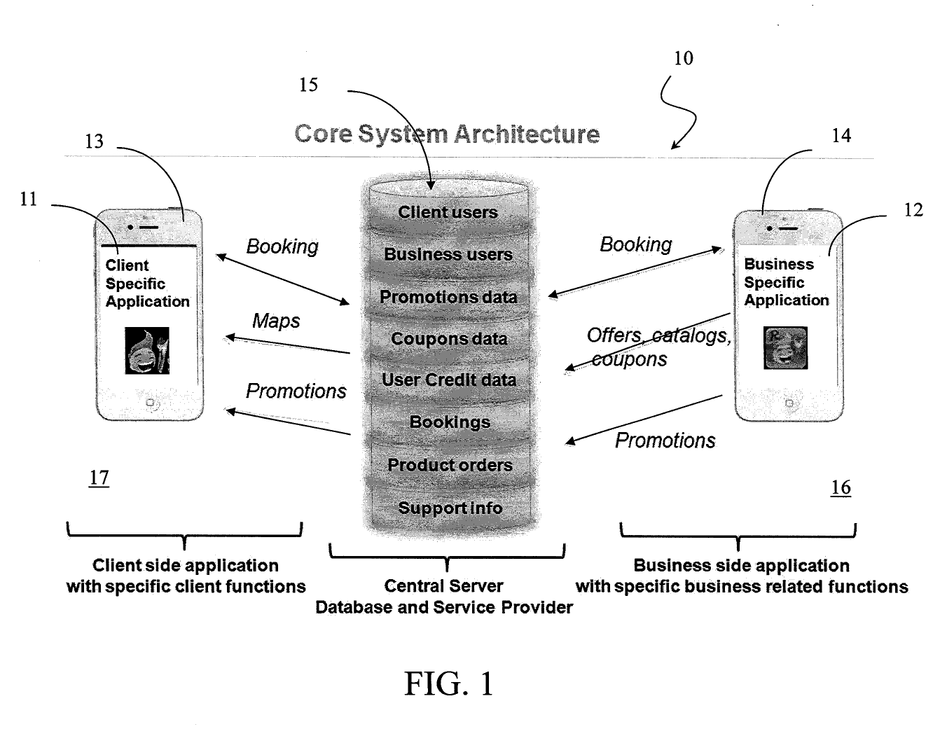

With reference to such figures, and in particular to FIG. 1, generally shown at 10 is a communication system architecture based on mobile applications according to an embodiment of the disclosure.

The communication system architecture 10 comprises:
a client user equipment 13 such as a smart phone, a tablet and the like provided with a client application 11;
a business user equipment 14 such as a smart phone, a tablet and the like provided with a business application 12; and
a central server 15 connected to the client user equipment 13 and to the business user equipment 14 through the corresponding client application 11 and business application 12, respectively.

According to an embodiment of the disclosure, the client application 11 and the business application 12 are different from one another, each one providing user-specific functions and communicating via formatted information; the communication being in particular enabled by a server software in the central server 15 providing both real time and deferred data transfers, as will be clarified in the following description.

It should be remarked that the supplier could be a factory, a firm, a professional and also a private person willing to provide services or products, even only occasionally.

In particular, the client and business applications are mobile apps and could be downloaded via an Apps Store, depending on the used equipment and operating system.

More in particular, the central server 15 could be based on PHP/My SQL technologies and running on a cloud servers service of a cloud provider so as to ensure full-time operations 24/7, data protection, redundancy and secure access.

The central server 15 thus uses an Internet connection to exchange messages with the client and business applications, 11 and 13. Moreover, the central server 15 processes received messages in conjunction with data suitably stored in the server itself, back and forth messages between the client and business applications being thus exchanged, as will be clarified by the following description.

More in particular, the central server 15 includes a set of key database lists relating to the client and business users information as well as the corresponding accounting and shopping data, as indicated in FIG. 1.

Such lists comprise, as a non-limiting example:
a client users list, containing information on the customer name, address, acceptance of the terms & conditions, equipment type, and, in case of a smart phone as client user equipment 13, the phone number and the phone identifier code UUID, which can be for example an iphone udid or uuid variants and versions such as the md5 field of the device mac address;
a business users list, containing information on the supplier name, address, acceptance of the terms & conditions, equipment type, and, in case of a smart phone as business user equipment 14, the phone number and the phone identifier code UUID, which can be for example an iphone udid or uuid variants and versions such as the md5 field of the device mac address;
a promotions data list, including multimedia content, comprising for instance text, images and/or videos and corresponding to promotional offers and to available coupons, if any;
a coupons data list, including a number of available coupons for a promotional offer and multimedia contents corresponding to the coupons and comprising, for instance, text, images or videos;
a user credit data list, indicating a credit amount as purchased by each supplier, such an amount being used to enable promotions, as will be explained in the following description;
a bookings list, including the customer identifier information as found in the client users list and business-related booking information;
a product orders list, including the list of the items as ordered by a customer user, the customer information and the date and time of each business transaction; and
a support info list comprising support questions-answers, for example, the questions come from the clients and the answers come from either the technical support team or other clients in the form of a blog list, typically.

In particular, according to an embodiment of the disclosure, the above indicated lists are stored in a SQL database of the central server 15.

In this way, the central server 15 is able to connect a client side 17 with specific client-friendly features to a business side 16 with specific business-related functions. More in particular, the central server 15 provides a communication platform where the client application 11 is a customer-specific application and provides the functions being needed to the customer, the business application 12 is a different business-specific application and provides the functions being needed to the supplier, and both the applications exchange relevant multimedia data in an instantaneous and secure manner. In particular, the exchanged data are formatted in a way to fit a specific business transaction, which is ensured by a server software of the central server 15, for instance running on cloud services.

For example, in case of a booking request for a car rental, the request could be formatted so as to include: pick-up date and time, restitution date and time, number of people, client driving license number, list of the cars being available for rental, and the client user selection, such information being stored in the lists of the central server 15 and being accessible both from the client user and the business user applications according to different view modes tied to the specific customer and supplier needs.

The central server 15 could be also coupled to a push server (not shown) which allows to push notifications relating promotions or coupons, for instance.

According to an embodiment of the disclosure, the push server is a portion of the central server 15, as an internal solution.

In this case, considering mobile phone applications for smart phones, the client user phone initiates a so-called mostly idle TCP/IP connection, i.e. a long-lived connection, and the central server 15, in particular its push server portion, sends keep-alive messages from time to time. Whenever a notification is addressed to a client user with which the central server 15 is operating such a long-lived connection, the push server portion sends a message to the client user phone over the TCP connection so as to perform a push notification.

Alternatively, the push server could be a third-party server, such as for example an Apple APN (acronym of “Apple Push Notification”), as an external solution.

The choice between the internal solution and the external solution as above described could depend on the used equipments, in particular the customer and supplier smart phones, and on the regional network performance.

As will be clear in the following description, the client application 11 and the business application 12 rely on some fundamental features of the operating systems running on the majority of the smart phones being on the market (such as iPhone, several Android-based models, several Windows mobile models, several Symbian models).

In particular, the client and business applications uses the available geolocalization and get the GPS coordinates from an embedded GPS chip of the smart phone, being accessed via the OS (Operating System) command that activates the GPS chip driver, or being estimated with the WiFi hotspot to which the smart phone is connected through its Internet connection, or with the cellular network in which case of 2G/3G/3.5G/LTE modem chips wherein a software provides an estimated geolocalization data thanks to the triangulation with the cellular base stations. The geolocalization information is then simply obtained by a call to the Operating System via its libraries.

Also, the time and date are provided by simple basic OS calls.

Moreover, the client application 11 and the business application 12 running on a smart phone may use Internet connection based on the TCP/IP protocol and conveyed through either a WiFi connection or the cellular connection of the smart phone itself. The TCP/IP protocol is used to send and receive data to/from the central server 15.

In order to clarify the operation of the communication system architecture according the disclosure, the exemplary case of a customer looking for a supplier, for instance a shop, in particular a restaurant, will be described, the system using at least a client application 11 downloaded on a client user equipment 13, in particular a smart phone of the customer and a business application 12 downloaded on a business user equipment 14, in particular a smart phone of the supplier.

The client application is preset so as to look for the supplier starting from the current position of the customer.

According to an embodiment of the disclosure, the client application 11, once in the on state, performs the following steps of:
checking the network to ensure an Internet connection is available, for example either a cellular connection EDGE/3.xG/LTE or a WiFi connection;
detecting a GPS position of the customer, in particular of the client user equipment 13; and
sending the GPS position and other information relating to the area around this position that could be displayed (for instance, within X Km) along with business transaction criteria for a business query (for instance the search of a restaurant) as provided by the customer to the central server 15 through the client application 11.

At this moment, the central server 15, on the basis of the received information from the client application 11, provides to the client user equipment 13 a result of the business query, for instance a map to be displayed wherein the restaurants in the selected area are indicated.

More in particular, in this specific case, the central server 15 activates a map tool, such as Google Places Map API (Application Programming Interface), in order to get map information of the selected area around the customer GPS position.

According to an embodiment of the disclosure, a server software of the central server 15 checks the business users list in order to determine the suppliers having downloaded and installed business applications 12 on their business user equipments 14. The server software also checks a general business list wherein the other businesses in the area are listed, i.e. the suppliers which have not downloaded and installed the business application 12. The server software then generates a result, in the form of a data for each supplier in the selected area, the data including at least the name, number and GPS position of the supplier, such a result being provided, along with the map data, to the client application 11.

In this way, the client application 11 is able to show the result of the business query in the form of a map with a plurality of pins, each corresponding to a supplier as found in the selected area.

According to an embodiment of the disclosure, the pins are different for different types of suppliers, in particular for the following groups:
suppliers with the business application 12;
suppliers without the business application 12;
suppliers with the business application 12 and accepting real-time booking;
suppliers with active promotions, according to the promotions data list of the central server 15; and
suppliers with active coupon-based promotions, according to the coupons data list of the central server 15, to name few.

More in particular, the different pins may have different colors and/or shape and/or size.

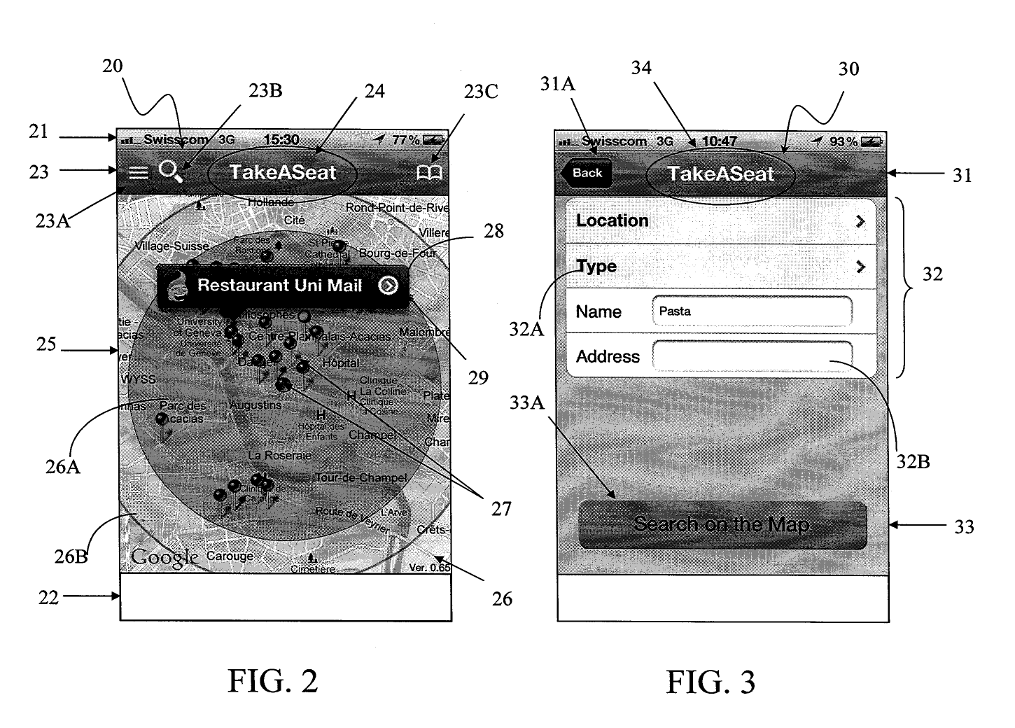

The result of a query for a restaurant in a selected area around the customer current position is shown by way of an example in FIG. 2. In particular, a default page 20 of the client application 11 is shown in a display of the client user equipment 13 as a screen shot.

The default page 20 is inserted between a general information portion 21, in turn including visual indications of the state of the client user equipment 13, such as the type and level of the mobile connection, the battery charge level and the current time, and a general advertising portion 22, which could be filled in with an advertising text or multimedia content.

The default page 20 particularly comprises a menu portion 23 including icons tied to the different commands of the client application 11, such as a list icon 23A, a search icon 23B and a booking icon 23C, to name few. A name 24 of the client application 11, such as a trademark name, is also shown in the menu portion 23.

Moreover, the default page 20 comprises a displaying portion 25, in turn including a map 26, wherein a first circular area 26A and a second circular area 26B are indicated, the areas being concentric around the current customer position as provided to the client application 11. The map 26 is provided by a map tool of the central server 15.

The map 26 also comprises a plurality of pins 27, each corresponding to a result of the business query made by the customer, in the considered example to a restaurant in the selected area. Moreover, each pin 27 has associated to a data strip 28 of the corresponding supplier, i.e. restaurant. In particular, a data strip 28 is shown when a selector or cursor is on the corresponding pin 27 and comprises, for instance, the name of the restaurant, an icon if the restaurant has the business application 12 as well as an access button 29, able to open an informational page or a booking page, as will be explained in the following description.

The query for a business transaction, in particular for a supplier, such as a restaurant, could be also made with different criteria, for instance for a position being different from the current position of the customer. In this case, the customer could move on the map 26 via the touch screen or keyboard of the client user equipment 13, in particular a smart phone. In this case, the map tool will suitably change the map 26 being displayed.

According to an embodiment of the disclosure, the client application 11 also comprises a query page, as shown by way of an example in FIG. 3, globally indicated with 30. In particular, the query page 30 is also displayed on the client user equipment 13 in the form of a screen shot and the access to this query page 30 is activated by an icon of the menu portion 23, for instance the search icon 23B.

The query page 30 comprises a menu portion 31, a selection portion 32 and a command portion 33. A name 34 of the client application 11, such as a trademark name, is also shown in the menu portion 31.

In particular, the menu portion 31 includes icons tied to the different commands of the client application 11, such as a back icon 31A which allows the return to the default page 20.

Moreover, the selection portion 32 comprises a plurality of search fields, for instance list-based search fields 32A and filter criteria search fields 32B. In particular, by using the list-based search fields 32A different locations or types of suppliers, namely restaurants, can be searched while using filter criteria search fields 32B specific filtering criteria could be applied to the search.

In the exemplary case of a search for a restaurant, a customer could search restaurant in a different city with respect to the one corresponding to the customer current position by selecting the city name in a list-based search field 32A indicated by Location in the figure. The customer could also select only restaurant of a specific type by indicating a food in a filter criteria search field 32B, namely Pasta in the figure.

Finally, a confirmation button 33A is provided in the command portion 33, activating a displaying of a map having a central position determined by the list-based search fields 32A. Such a map is also provided by the map tool of the central server 15, as the map 26 shown in FIG. 2. Also in this case, the map comprises a plurality of pins, each corresponding to a result of the business query made by the customer through the query page 30, in particular to a restaurant in the selected area and of the type corresponding to the list-based search fields 32A, duly complying to the requirements of the filter criteria search fields 32B, if any.

As already explained, as a default page 20 or as a result of a business query made through the query page 30, the client application 11 shows a map 26 with a plurality of pins 27, each corresponding to the result of the business query made by the customer. In particular, the pins 27 may have different colors and/or shape and/or size characterizing the suppliers having the business application 12, active promotions, or promotions with a number of coupons. By clicking on a pin 27, the customer can then get in touch with the chosen supplier, for instance the chosen restaurant.

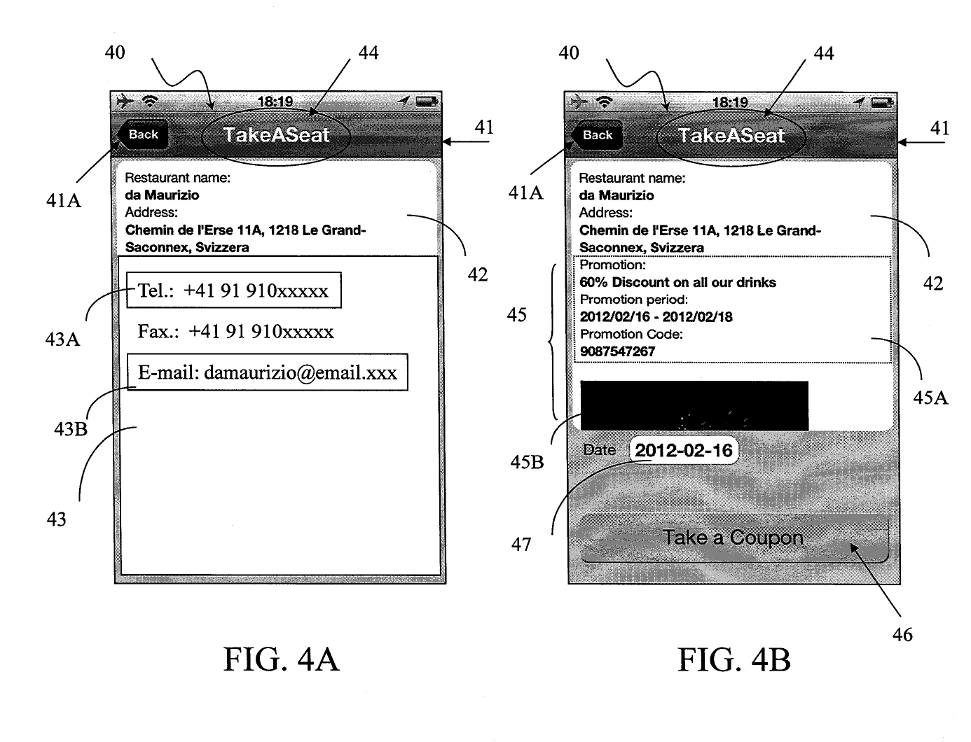

If the chosen supplier has no business application 12, clicking on the corresponding pin 27 as shown in the map 26, the customer could access details such as name, address, phone number of the supplier in a further informational page 40, as shown in FIG. 4A.

More in particular, the informational page 40 comprises a menu portion 41, a view-only informational portion 42 and a selectable informational portion 43.

As previously, the menu portion 41 includes icons tied to the different commands of the client application 11, in particular a back icon 41A which allows the return to the default page 20 or to the query page 30. A name 44 of the client application 11, such as a trademark name, is also shown in the menu portion 41.

The view-only informational portion 42 comprises different data relating to the chosen supplier corresponding to the selected pin 27, for example the name and the address of the supplier, while the selectable informational portion 43 comprises at least one selectable field comprising a data of the chosen supplier which is directly usable by the client user equipment 13, in particular a smart phone. In the example shown in FIG. 4A, the selectable informational portion 43 comprises a first selectable field 43A including the phone number of the supplier, and a second selectable field 43B comprising its e-mail address.

In this way, by clicking on the first selectable field 43A, the phone API is called and the customer smart phone calls the phone number of the chosen supplier, i.e. restaurant.

According to another embodiment of the disclosure, the informational page 40 could also comprise a promotional portion 45, being tied to a promotion and/or a coupon offered by the supplier, as shown in FIG. 4B. By way of an example, the promotional portion 45 in turn includes an informational textual portion 42A and a multimedia portion 42B, for instance a picture.

The informational page 40 also comprises a confirmation button 46 which allows the customer to pick up the promotion and/or the coupon as offered. A date selection field 47 could be also comprised in the informational page 40 so as to link the promotion and/or the coupon to a chosen date—

In particular, the informational page 40 would comprise such promotional portion 45 for the suppliers having active promotions, which are displayed in the map 26 by means of pins 27 having, for instance, a specific color.

It should be considered that only a limited number of coupons is available, the special offer of the supplier being thus reserved for a limited number of customer. It could be considered a first come first served rule for the assignment of such coupons. As explained above, the customer could apply for a coupon by using the confirmation button 46 of the informational page 40 of the client application 11 until all coupons are taken.

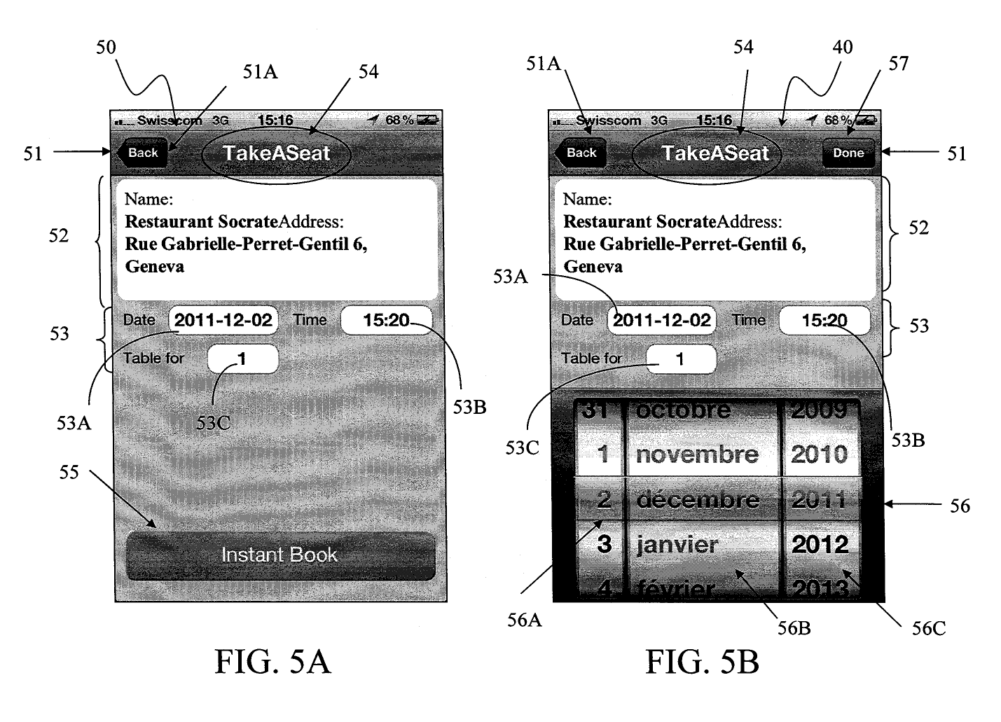

According to an embodiment of the disclosure, the client application 11 also comprises a booking page, as shown in FIG. 5A, globally indicated with 50. As will be clear from the following description, the booking page 50 is accessed by clicking on an icon of the menu portion 23 of the default page 20, in particular the booking icon 23C, and allows for a real-time booking if the chosen supplier has the business application 12, as indicated by the corresponding pin 27 having a specific color and also from an icon shown on the data strip 28.

The booking page 50 in particular comprises a menu portion 51, an informational portion 52 and a selection portion 53.

More in particular, the menu portion 51 includes icons tied to the different commands of the client application 11, in particular a back icon 51A which allows the return to the default page 20 or to the query page 30. A name 54 of the client application 11, such as a trademark name, is also shown in the menu portion 51.

The informational portion 52 comprises different data relating to the chosen supplier corresponding to the selected pin 27, for example the name and the address of the restaurant, while the selection portion 53 comprises a plurality of data fields wherein the data relating to the business transaction, in particular the booking of a restaurant seat, could be inserted. In the example shown in FIG. 5A, the selection portion 53 comprises a first data field 53A allowing the insertion of a booking date, a second data field 53B allowing the insertion of a booking time and a third data field 53C allowing the insertion of a booking amount, for instance the number of people at a table.

The booking page 50 also comprises a confirmation button 55 which allows the customer to perform a real-time booking.

According to an embodiment of the disclosure, the data fields of the selectable informational portion 53 are associate to pre-defined data fields that the customer could scroll in order to choose the required data, as shown in FIG. 5B. In the example of this figure, the selectable informational portion 53 the first data field 53A is associated to a scrollable pre-defined data field 56 which allows the insertion of the booking date by suitably scrolling a roller having a first sliding portion 56A for the selection of the booking date day, a second sliding portion 56B for the selection of the booking date month and a third sliding portion 56C for the selection of the booking date year. A confirmation button 57 is in this case provided in the menu portion 51 of the booking page 50, allowing the customer to confirm the selected combination of the sliding portions of the scrollable pre-defined data field 56.

The operation of the client application 11 could be resumed as follows.

The client user equipment 13 firstly shows the default page 20 wherein a map 26 is for instance depicted, along with a plurality of pins 27 indicating the different suppliers in the selected area.

By clicking on a pin 27 of the map 26, the client application 11 shows in its default page 20 the data strip 28 comprising the information about the supplier corresponding to the clicked pin 27, the information being provided by the central server 15. This information may include promotional information also sent by the central server 15 when available in the promotions data list and it is indicated to the customer by changing the pin aspect, in particular its color.

When the customer clicks on the access icon 29 of the data strip 28, the client application 11 open the informational page 40.

In case of a supplier without the business application 12, the informational page 40 only allows the customer to view the supplier data and to contact it by phone or e-mail, when the client user equipment 13 is a smart phone.

When the supplier has the business application 12, the informational page 40 may also comprise a promotional portion 45, being tied to a promotion and/or a coupon offered by the supplier and a confirmation button 46 which allows the customer to pick up the promotion and/or the coupon as offered.

The customer may also access the query page 30 by clicking on the search icon 23B of the menu portion 23 of the default page 20. In particular, a business query could be performed thanks to the query page 30, for instance a search for a restaurant in other city that the one corresponding to the customer current position, or filter the result on some criteria (for instance, the search may select only Pizza or Sushi restaurants).

Moreover, the booking page 50 may be accessed by clicking on the booking icon 23C of the menu portion 23 of the default page 20, allowing the customer to perform the real-time booking by selecting date, time and other formatted business specific information.

Finally, at any time the customer may access a booking list by clicking on the list icon 23A of the menu portion 23 of the default page 20, in order to see the stored bookings and also to access the available promotional information connected to the listed bookings.

In this way, the client application 11 allows to a customer to search for a supplier in a selected area, to display the information and active promotions of the suppliers in this selected area, to take a coupon for an coupon-based promotion as well as to apply for a business transaction, in particular a booking request. As will be explained in the following description, the customer may also make a real-time business transaction, in particular a booking and receive a confirmation thereof.

In order to allow a real-time business transaction, the communication system architecture also comprises a business application 12 on a business user equipment 14, which receives the business transaction request from the client application 11 through the central server 15, in particular a PHP server on a specific server URL dedicated to the business transaction in re.

The central server 15 sends a push notification to the business application 12, as explained in the following description in more detail.

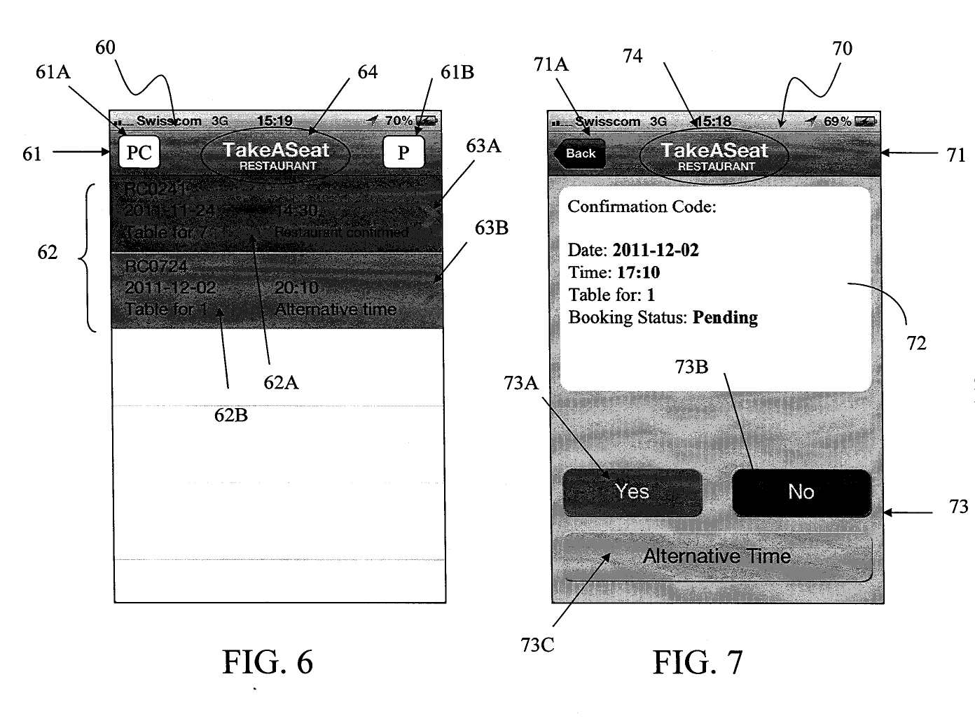

Once a push notification is received, the business application 12 shows a push page as a default page, as shown in FIG. 6, globally indicated with 60.

The push page 60 comprises a menu portion 61 and a business transaction list 62 of a plurality of business transaction requests. The menu portion 61 includes icons tied to the different commands of the business application 12, such as a coupon icon 61A and a promotion icon 61B. A name 64 of the business application 12, such as a trademark name, is shown in the menu portion 61.

In the example shown in the figure, the transaction list 62 is a list of the booking requests, 62A, 62B, each provided with a respective access button 63A, 63B.

The transaction list 62 comprises the essential data provided by the customers through their client applications 11, and in particular the data inserted into the booking page 50.

By clicking on the access button 63A, 63B, a booking confirmation page 70 is accessed, as shown in FIG. 7.

The booking confirmation page 70 comprises a menu portion 71, an informational portion 72 and a command portion 73. A name 74 of the business application 12, such as a trademark name, is also shown in the menu portion 71.

In particular, the menu portion 71 includes icons tied to the different commands of the business application 12, such as a back icon 71A which allows the return to the push page 60.

The informational portion 72 comprises the essential data provided by the customers through their client applications 11, and in particular the data inserted into the booking page 50.

The command portion 73 in turn includes a plurality of command buttons, in particular an accept button 73A, a deny button 73B and a new proposal button 73C which allows a supplier to accept, deny, or propose new options to the customer, in the example of a booking request for a restaurant, a new timing could be proposed to the customer.

If the business transaction is accepted, by clicking on the accept button 73A, the business application 12 stores the business transaction. In this case, a confirmation message is sent to the central server 15.

When a confirmation message that a business transaction is accepted is received, the central server 15 stores the accepted business transaction and notifies the customer with a push notification which also sends a confirmation number to the client application 11. According to an embodiment of the disclosure, the client application 11 shows the received confirmation on a pop-up window and have the information stored in the booking list being accessed by clicking on the list icon 23A of the menu portion 23 of the default page 20.

When the business transaction is denied, by clicking on the deny button 73B, the business application 12 sends a deny message to the central server 15. When a deny message that a business transaction is denied is received, the central server 15 notifies the customer with a push notification. According to an embodiment of the disclosure, the client application 11 have the information stored in the booking list being accessed by clicking on the list icon 23A of the menu portion 23 of the default page 20.

In case the supplier wants to modify the required business transaction, he will do so based on the business transaction related formatted options, for instance, in the case of a booking for a restaurant table, by providing a different time. By clicking on the new proposal button 73C, the modified business transaction information as proposed is pushed to the central server 15, which sends it to the client application 11.

According to an embodiment of the disclosure, the client application 11 shows the received modified business transaction information on a pop-up window and the customer may choose, within a pre-defined delay to either accept or discard the new business transaction.

If the customer accepts the received business transaction as modified, the central server 15 stores the accepted modified business transaction and notifies the customer with a push notification which also sends a confirmation number to the client application 11. According to an embodiment of the disclosure, the client application 11 shows the received confirmation on a pop-up window and have the new information stored in the booking list being accessed by clicking on the list icon 23A of the menu portion 23 of the default page 20.

If the customer denies the received business transaction as modified, the central server 15 notifies the supplier about such denial with a push notification to the business application 12.

It should be remarked that the push notification service is different for different operating systems. However, it is known that smart phones usually poll the push notification service provider and checks if there are ongoing notifications addressed to them; the notification being a piece of data with at least a unique identifier of the recipient, a code and a text to be notified.

According to an embodiment of the disclosure, the push notifications are provided by the central server 15, particularly delivered, as previously indicated, by either a third-party push server or by a push server portion of the central server 15 itself depending on the used smart phones and on the regional network performance. The push notification includes a code that the client application 11 or the business application 12 could interpret and associate to a specific message, such as “booking accepted” or “booking refused”. In particular, when a notification is found in the push server, it is read through the data connection between the smart phone and the push server, and, for instance, displayed as a window or icon on top of any other applications running on the phone, depending on the smart phone and user settings. For example, the window or icon tied to the push message could appear in the center of the screen of the smart phone or on the top of it or being just hidden. Moreover, such a window or icon could be also associated to a sound or a vibration of the smart phone.

According to an embodiment of the disclosure, the business application 12 also allows a supplier to publish promotions with coupons by using the business user equipment 14.

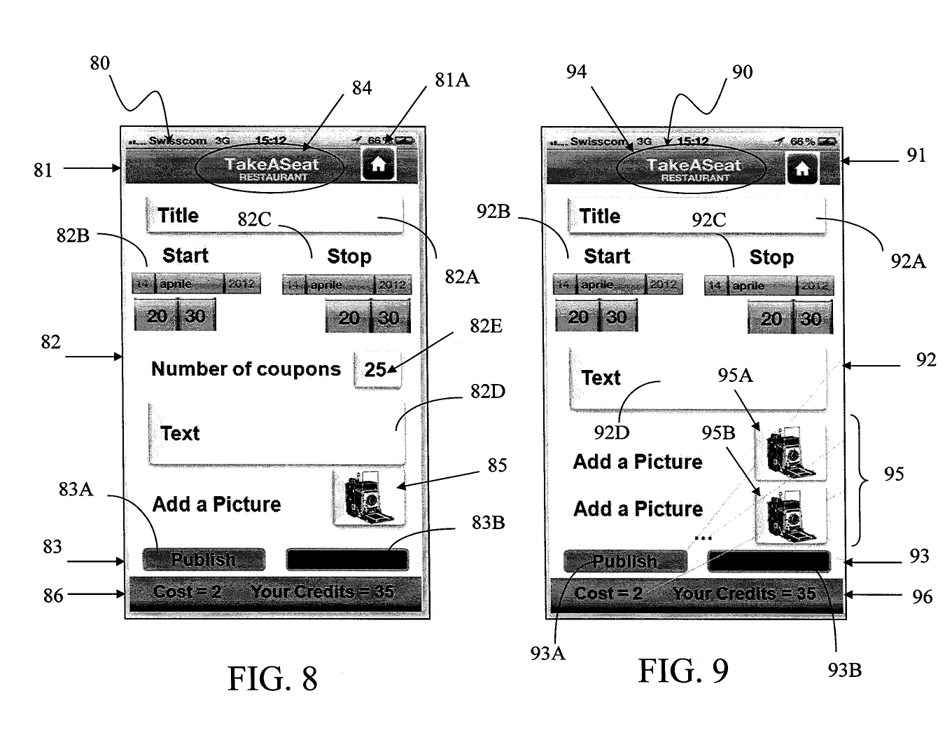

In this aim, the business application 12 comprises a coupon page as shown in FIG. 8, globally indicated with 80, being accessed by clicking on an icon of the menu portion 61 of the push page 60, in particular the coupon icon 61A.

The coupon page 80 comprises a menu portion 81, a data portion 82 and a command portion 83.

In particular, the menu portion 81 includes icons tied to the different commands of the business application 12, such as a back icon 81A which allows the return to the push page 60. A name 84 of the business application 12, such as a trademark name, is also shown in the menu portion 81.

The data portion 82 comprises a plurality of fields to be filled in with the essential data relating to the coupon being offered by the supplier. In particular, in the example of the figure, the data portion 82 comprises a title field 82A, a start date field 82B, a stop date field 82C, a text field 82D as well as a coupon number field 82E.

The coupon page 80 also comprises an uploading button 85, which allows the supplier to add a picture to the coupon.

In this way, through the coupon page 80 of the business application 12, a supplier could prepare a promotion with coupons, by describing such a promotion with multimedia content (text, duration of the deal, pictures) and a number of coupons tied to it, all the information being directly inserted by using the business user equipment 14, in particular a smart phone. The multimedia content could be also taken from other sources such as e-mail messages or other web application through a web browser already present in any smart phone.

The command portion 83 in turn includes a plurality of command buttons, in particular a publish button 83A and a de-activate button 83B which allows a supplier to publish a promotion with coupons and to stop it.

Finally, the coupon page 80 also comprises an informational portion 86, showing the cost of the promotion with coupons and the available credits of the supplier. The information relating the available credits of each supplier are stored in the user credit data list of the central server 15.

Similarly, the business application 12 allows a supplier to publish promotion by using the business user equipment 14.

In this aim, the business application 12 comprises an add promotion page as shown in FIG. 9, globally indicated with 90, being accessed by clicking on an icon of the menu portion 61 of the push page 60, in particular the promotion icon 61B.

The add promotion page 90 comprises a menu portion 91, a data portion 92 and a command portion 93.

In particular, the menu portion 91 includes icons tied to the different commands of the business application 12, such as a back icon 91A which allows the return to the push page 60. A name 94 of the business application 12, such as a trademark name, is also shown in the menu portion 91.

The data portion 92 comprises a plurality of fields to be filled in with the essential data relating to the promotion being offered by the supplier. In particular, in the example of the figure, the data portion 92 comprises a title field 92A, a start date field 92B, a stop date field 92C and a text field 92D.

The add promotion page 90 also comprises an uploading portion 95, in the example comprising at least a first and a second button, 95A e 95B, which allow the supplier to add pictures to the promotion.

In this way, through the add promotion page 90 of the business application 12, a supplier could prepare a promotion, by describing such a promotion with multimedia content (text, duration of the deal, pictures), all the information being directly inserted by using the business user equipment 14, in particular a smart phone. As previously, the multimedia content could be also taken from other sources such as mail messages or other web applications through a web browser already present in any smart phone.

The command portion 93 in turn includes a plurality of command buttons, in particular a publish button 93A and a de-activate button 93B which allows a supplier to publish a promotion and to stop it.

Finally, the add promotion page 90 also comprises an informational portion 96, showing the cost of the promotion and the available credits of the supplier. The information relating the available credits of each supplier are stored in the user credit data list of the central server 15.

According to an embodiment of the disclosure, the available credits relating to each supplier are periodically sent, for instance once a day, to the corresponding business applications 12.

When a publication of a promotion, with or without coupons, is started by clicking on the publish button 83A or 93A, the business application 12 firstly checks if the supplier has enough credits.

In case of sufficient credits, the whole set of multimedia information relating to the promotion and inserted in the data fields of the data portion 82 or 92 is sent to the central server 15, in particular via the Internet connection to the proper PHP URL that indicates which part of the central server 15 is concerned. Also in this case, considering smart phones as business user equipments, the multimedia information is associate to the UID unique identified of the smart phone.

The central server 15 then stores the information in the coupons data list or promotions data list, associated with the identifier of the smart phone belonging to the corresponding supplier as registered in the business users list. Moreover, the promotion is flagged active as long as the time/date are within the set time/date period of the promotion, as defined by the start date field 82B or 92B and the stop date field 82C or 92C.

From that moment, each times a customer clicks on a pin on the map as provided by the corresponding client application 11, the informational page 40 opens and shows basic information plus the abovementioned promotion, for as long as the promotion is active.

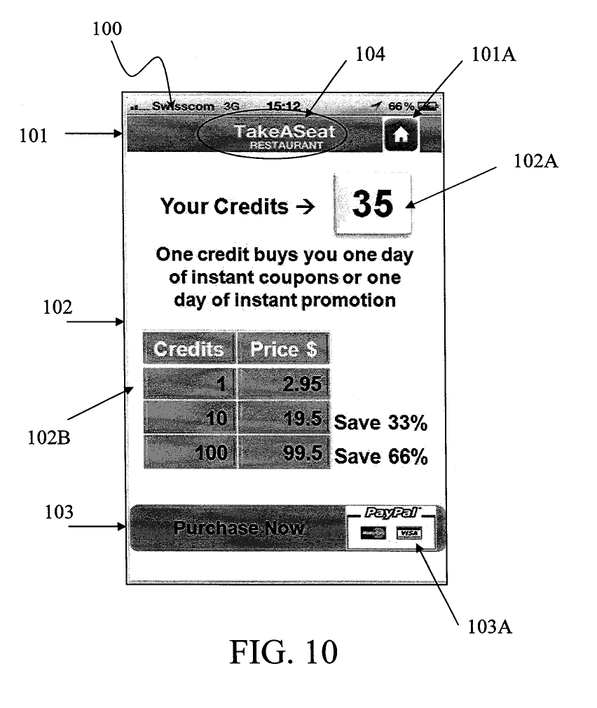

In case of insufficient credits for the supplier requiring the publication of the promotion with coupons, the business application 12 displays a buy credits page, as shown in FIG. 10, globally indicated with 100.

The buy credits page 100 comprises a menu portion 101, an informational portion 102 and a command portion 103.

In particular, the menu portion 101 includes icons tied to the different commands of the business application 12, such as a back icon 101A which allows the return to the push page 60. A name 104 of the business application 12, such as a trademark name, is also shown in the menu portion 101.

The informational portion 102 comprises a plurality of fields relating to the credits situation of the supplier. In particular, in the example of the figure, the informational portion 102 comprises an available credits field 102A, showing the credits amount still available for the supplier and an offer field 102B, showing the prices of new credits to be bought.

The supplier could buy new credits by clicking on a command button 103A in the command portion 103, being connected to a payment tool.

The credits amount shown in the available credits field 102A is updated each time a supplier purchases credits via the buy credits page 100 of the business application 12, the new credits amount being also sent to the business application 12.

According to an embodiment of the disclosure, the buy credits page 100 uses a mobile payment API, such as PayPal or Apple InApp purchases, being accessed by clicking on the command button 103A in the command portion 103.

According to another embodiment of the disclosure, by clicking on the command button 103A, a link to a web payment page is provided, so as to access to such a web page through an Internet browser, for instance the browser of the used business user equipment 14, in particular a smart phone.

The credits amount shown in the available credits field 102A is also updated each time a supplier publishes a promotion, with or without coupons, the new credits amount being sent to the business application 12.

Considering for instance the PayPal tool in InApp systems, the supplier identify himself and proceeds with the purchase on a server belonging to the respective service provider. The provider sends back confirmation of the order to the central server 15. The central server 15 then allows as much credits as the corresponding payment and stores the new available credits in its user credits list.

The operation of the business application 12 could be resumed as follows.

The business user equipment 14 firstly shows the push page 60 wherein a plurality of business transaction requests of the business transaction list 62 is shown.

The transaction list 62 comprises the essential data provided by the customers through their client applications 11, and in particular the data inserted into the booking page 50.

Starting from the transaction list 62, after one access button 63A or 63B has been clicked, the business application 12 opens the booking confirmation page 70.

If the business transaction is accepted, by clicking on the accept button 73A, the business application 12 stores the business transaction and send a confirmation message to the central server 15 wherein the accepted business transaction is stored. The central server 15 also notifies the customer with a push notification and sends a confirmation number to the client application 11 which stores the accepted business transaction in the booking list.

If the business transaction is denied, by clicking on the deny button 73B, the business application 12 send a deny message to the central server 15 which notifies the customer with a push notification, the corresponding client application 11 storing the denial in the booking list.

In case the supplier modifies the required business transaction, by clicking on the new proposal button 73C, the modified business transaction information as proposed is pushed to the central server 15, which sends it to the client application 11 and the customer may choose, within a pre-defined delay to either accept or discard the new business transaction.

According to an embodiment of the disclosure, when the customer clicks on a colored pin 27 corresponding to a supplier which has published a promotion, with or without coupons, the client application 11 sends a request to the central server 15 asking to retrieve all the information associated to the chosen supplier, in particular the business information and the promotional information.

In this case, the central server 15 searches for the chosen supplier in the business user and promotions data in the respective lists and send it back to the client application 11 via the Internet connection. In particular, the information is displayed in the promotional portion 45 of the informational page 40 as shown in FIG. 4B.

In case of a promotion with coupons, by clicking the confirmation button 46 in the informational page 40 the customer could pick up the coupon as offered. In this case, the client application 11 sends a corresponding request to the central server 15. Moreover, the client application 11 stores in its booking list the taken coupon and the corresponding promotion, being accesses by clicking on the list icon 23A of the menu portion 23 of the default page 20. According to an embodiment of the disclosure, only one coupon per client application is allowed.

The central server 15, when receiving such a coupon request from a client application 11, decreases by one unit the number of available coupons in the coupons data list associated to the chosen promotion, indicating that one user has take one coupon and there is therefore one less available.

As already indicated, the coupons have a duration as defined by the start date field 82B and the stop date field 82C, and, according to an embodiment of the disclosure, after it expires, the bookings list will indicate that expiration with a text and a different color. At the same time the central server 15 will also change a flag on the coupons data list indicating that the promotion is expired, so that when another client will search for promotions the colored pins on his map will appear with the right color.

According to another embodiment of the disclosure, a business mobile registration process is also considered.

According to this registration process, the first time a supplier or business user downloads the business application 12 on a business user equipment 14, in particular a smart phone, he is required to register himself.

Registering means identifying his business so that improper use or stolen identity are avoided.

According to an embodiment of the disclosure, in order to register himself, the business user inserts required identification data, such as e-mail address, a password and a phone number, to name few.

More in particular, in order to identify himself on a map such as the map 26 provided to the client application 11, the business user should usually insert an address, from which the central server 15 will then calculate the GPS coordinates. In alternative, the business user could manually point his position on a provided map. According to an embodiment of the disclosure, the map is displayed on the business user equipment 14 thanks to the Google Places API information send by the central server 15 via the Internet connection in order to show a map centered on a geolocalized current position of the business user, or at least of the business user equipment 14, also allowing the business user to scroll and zoom the map until his correct address and place of business is found. The location founded in the map is stored as the GPS location of the business user.

After that, the user and location information, plus the smart phone UID, if any, are then sent to the central server 15 and stored in the business users list, serving as reference place and basic information about the business user.

After the registration process, a supplier would be able to:
use the business application 12 and in particular perform the real-time booking as above described. The supplier
publish promotions
publish promotions with coupons
buy credits

In this way, the business application 12 allows to provide a real-time booking service, each business transaction being confirmed or instantaneously modified interacting with the customer. The business application 12 also allows a supplier to publish promotional information, being generates on the business user equipment 14 and instantaneously pushed to the client applications 11 of the client user equipments 13. As already explained, the promotions could be associated to a limited number of coupons to attract customers.

According to an embodiment of the disclosure, the client and business applications may be merged into a sole mobile application allowing to switch to either a client user interface or a business user interface.

In particular, a single mobile application could be downloaded and installed, this single mobile application comprising a client interface for a customer-specific application 11 providing the functions being needed to the customer and a business interface for a business-specific application 12 providing the functions being needed to the supplier and exchanging relevant multimedia data in an instantaneous and secure manner, the exchanged data being formatted in a way to fit a specific business transaction, which is ensured by the server software of the central server 15.

In essence, the described communication system architecture performs a method of providing real-time supplier-to-customer communications and transactions based on user-specific applications being in connection with a central server, so as to allow the business transactions to be immediately confirmed, denied or changed.

The method comprises the following steps:
launching a client application 11 of a client user equipment 13, in particular a smart phone;
starting a business query by the client application 11 by default based on geolocalization of the client user equipment 14;
inserting a business query by a customer through the client application 11, for instance a search for a restaurant in a selected area;
sending the business query criteria to a central server 15 in order to establish a query result including the suppliers meeting the business query criteria;
sending the query result to the client application 11 in order to show it onto the client user equipment 13, in particular by means of a map 26 with a plurality of pins 27 corresponding to the different suppliers found in the selected area, the supplier having been geolocalized in the map 26;
selecting a supplier by the customer through the client application 11, in particular by clicking on a corresponding pin 27 of the shown map 26;
providing business transaction data being duly formatted;
sending the business transaction data to the central server 15 which pushes the business transaction data to the business application 12; and
receiving an immediate reply from the business application 12 toward the central server 15 which pushed the reply to the client application 11.

As already described, the business application 12 may accept, deny, or propose new options for the business transaction.

When the business transaction is accepted, the method comprises storing the accepted business transaction in the central server 15, which pushes a notification comprising a confirmation number to the client application 11.

Moreover, when the business transaction is denied, the method comprises sending a deny message to the central server 15, which pushes a notification of denial to the client application 11.

In these cases, the method also comprises storing the information about the accepted and/or denied business transactions in the booking list of the client application 11.

Finally, when the supplier wants to change the required business transaction, the method further comprises sending the new business transaction data by the business application 12 to the central server 15 which pushes the new business transaction data to the client application 11 and receiving a reply by the client application 11 to the central server 15, which pushes the reply to the business application 12.

According to an embodiment of the disclosure, providing business transaction data being duly formatted comprises accessing to a business transaction insertion page, in particular a booking page 50 of the client application 11, in order to insert the business transaction data in respective duly formatted data fields, for instance scrollable pre-defined data and time fields, pre-defined products and service menus.

According to an embodiment of the disclosure, the method further comprises taking an individual promotional coupon by the client application 11. In this case, the method also comprises publishing promotions with a limited number of coupons, including text, audio, animations and videos by the business application 12.

According to an embodiment of the disclosure, the publishing of promotions comprises publishing promotion information including multimedia content generated by the business user equipment 14 or imported from other sources, such as photo catalogs, e-mails, web pages.

The publishing promotion information may comprise publishing promotion information by the business application 12 to the central server 15, which then pushes the permanent promotion information to the client application 11 so as to be made visible to the client user equipment 13, in particular a smart phone.

Moreover, the method may comprise buying credits by the suppliers through the respective business applications 12, the credits being consumed when publishing promotions and when delivering coupons, if any.

According to an embodiment of the disclosure, the query result may be established by taking into account the geolocalization of the customers and of the suppliers.

According to an embodiment of the disclosure, the method comprises checking if the suppliers of the query result have the business application 12 and showing them with a specific signal, for instance a pin having a specific color. Moreover, the method comprises checking if the suppliers of the query result have promotions, with or without coupons, and showing them with respective specific signals, for instance pins having different colors.

According to another embodiment of the disclosure, the method comprises a registration process of a supplier having a business application 12, comprising providing a geolocalization.

Finally, the method may comprise replicating the information available from a business application 12 in a respective business user equipment 14 of a supplier onto a personal web page, being managed by the central server 15, allowing the supplier to access business related information from a personal computer or a notebook as well as through a mobile device.

It should be remarked that the method and the architecture according to the embodiments of the disclosure allow to establish a communication between a client application and a business application, these applications being different, each one providing user-specific functions and meeting user-specific need, by way of suitably formatted information being exchanged through a central server to which the applications are connected.

In this way, it is provided a service that is real-time, geo-localized and mobile for both the customers and suppliers, being also tailored according to the specific needs. In fact, being all product and services different one another, considering for instance restaurants, haircut, SPA, massages-centers, beauty-centers, retailers of consumer goods, car rentals, taxi, bicycle rentals, clothes shops, private persons willing to perform, even occasionally, business transactions on personal goods, to name few, the use of client applications and business applications allows to correctly perform real-time and mobile business transactions at the same time providing common business-specific information being formatted per each kind of such business transactions, thus facilitating the business transactions themselves and also providing specific functions to fit the need of each of the two parties, i.e. the customers and suppliers.

Moreover, it should be remarked that the different functions of the client and business applications could be directly made by the client and business user equipments, respectively.

Finally, it should be also remarked that the method and the architecture according to the embodiments of the disclosure is easy to be used both for the suppliers and the customers.

From the foregoing it will be appreciated that, although specific embodiments of the disclosure have been described herein for purposes of illustration, various modifications may be made without deviating from the spirit and scope of the disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of providing real-time supplier-to-customer communications and transactions based on a client application and a business application installed onto respective client user mobile equipment and business user mobile equipment and in connection with a central server, the method comprising:
starting a business query by the client application by default based on geolocalization of the client user equipment;
receiving business query criteria from a customer through the client application;
sending the business query criteria to the central server in order to establish a query result including the suppliers meeting the business query criteria;
sending the query result to the client application in order to show it onto the client user equipment;
receiving a supplier selection from the customer through the client application;
providing business transaction data that is duly formatted;
sending the business transaction data to the central server which pushes the business transaction data to the business application; and
receiving an immediate reply from the business application toward the central server which pushed the reply to the client application, so as to allow the business transactions to be immediately confirmed, denied or changed.

2. The method of claim 1, further comprising, when the business transaction is accepted, storing the accepted business transaction in the central server, which pushes a notification comprising a confirmation number to the client application.

3. The method of claim 2, further comprising storing the information about the accepted business transactions in the booking list of the client application.

4. The method of claim 1, further comprising, when the business transaction is denied, sending a deny message to the central server, which pushes a notification of denial to the client application.

5. The method of claim 4, further comprising storing the information about the denied business transactions in the booking list of the client application.

6. The method of claim 1, further comprising, when the supplier wants to change the required business transaction:
sending new business transaction data by the business application to the central server which pushes the new business transaction data to the client application, and
receiving a reply by the client application to the central server, which pushes the reply to the business application.

7. The method of claim 1, wherein providing business transaction data being duly formatted comprises accessing to a business transaction insertion page of the client application, in order to insert the business transaction data in respective duly formatted data fields.

8. The method of claim 1, further comprising taking an individual promotional coupon by the client application directly from the client user equipment.

9. The method of claim 8, further comprising publishing promotions directly from the business user equipment with a limited number of coupons, including text, audio, animations and videos by the business application.

10. The method of claim 1, further comprising publishing promotions by publishing promotion information directly from the business user equipment including multimedia content generated by the business user equipment or imported from other sources, such as photo catalogs, e-mails, web pages.

11. The method of claim 10, wherein publishing promotions information comprises publishing promotion information by the business application to the central server, which then pushes the promotion information to the client application so as to be made visible to the client user equipment.

12. The method of claim 11, further comprising buying credits by the suppliers through the respective business applications directly by the business user equipments, the credits being consumed when publishing promotions.

13. The method of claim 9, further comprising buying credits by the suppliers through the respective business applications directly by the business user equipments, the credits being consumed when delivering coupons.

14. The method of claim 1, further comprising establishing the query result by taking into account the geolocalization of the customers and of the suppliers.

15. The method of claim 14, further comprising showing the query result by means of a map with a plurality of pins corresponding to the different suppliers found in the selected area, the suppliers having been geolocalized in the map, the map being scrollable by the customer.

16. The method of claim 14, further comprising checking if the suppliers of the query result have the business application and/or have promotions, with or without coupons and showing them with a specific signal.

17. The method of claim 16, further comprising showing the query result by means of a map with a plurality of pins corresponding to the different suppliers found in the selected area, the suppliers having been geolocalized in the map by means of a pin having a specific color if the suppliers have the business application and/or have promotions, with or without coupons, the map being scrollable by the customer.

18. The method of claim 1, further comprising providing a mobile registration process of a supplier having the business application on his business user mobile equipment, comprising providing a geolocalization, or by pointing directly at localization point on the map.

19. The method of claim 1, further comprising replicating the information available from the business application in the business user mobile equipment of a supplier onto a personal web page of the supplier, being managed by the central server.

20. A communication system architecture comprising:
a client application configured to run on a client user equipment;
a business application configured to run on a business user equipment; and
a central server connected to the client user equipment and to the business user equipment through the corresponding client application and business application, respectively,
the client application and the business application being different from one another, each one providing user-specific functions and communicating via formatted information; the communicating being enabled by server software in the central server providing both real time and deferred data transfers in order to send a business transaction request by the client application and receive an immediate reply from the business application about the business transaction being confirmed, denied or changed.

21. The architecture of claim 20, wherein the client and business applications are mobile apps.

22. The architecture of claim 20, wherein the client and business applications are merged into a sole mobile application allowing to switch to either a client user interface or a business user interface.

23. The architecture of claim 20, wherein the central server includes a set of key database lists relating to the client and business users information as well as the corresponding accounting and shopping data.

24. The architecture of claim 23, wherein the set of key database lists of the central server comprise:
a client users list, containing information on the customer name, address, acceptance of the terms & conditions, equipment type, and, in case of a smart phone as client user equipment, the phone number and the phone identifier code;
a business users list, containing information on the supplier name, address, acceptance of the terms & conditions, equipment type, and, in case of a smart phone as business user equipment, the phone number and the phone identifier code;
a promotions data list, including multimedia content, comprising for instance text, images and/or videos and corresponding to promotional offers, both for products and services—and to available coupons, if any;
a coupons data list, including a number of available coupons for a promotional offer and multimedia contents corresponding to the coupons and comprising, for instance, text, images or videos;
a user credit data list, indicating a credit amount as purchased by each supplier, such an amount being used to enable promotions;
a bookings list, including the customer identifier information as found in the client users list and business-related booking information;
a product orders list, including the list of the items as ordered by a customer, the customer information and the date and time of each business transaction; and
a support info list comprising support questions-answers.

25. The architecture of claim 20, wherein the central server provides a communication platform where the client application is a customer-specific application and provides the functions being needed to the customer, the business application is a different business-specific application and provides the functions being needed to the supplier, and both the applications exchange relevant multimedia data in an instantaneous and secure manner, the exchanged data being formatted in a way to fit a specific business transaction, which is ensured by the server software of the central server.

26. The architecture of claim 20, wherein the central server provides a communication platform where a single mobile application comprises a client interface for a customer-specific application providing the functions being needed to the customer and a business interface for a business-specific application providing the functions being needed to the supplier, the single mobile application exchanging relevant multimedia data in an instantaneous and secure manner, the exchanged data being formatted in a way to fit a specific business transaction, which is ensured by the server software of the central server.

27. The architecture of claim 20, wherein the central server is coupled to a push server which allows to push notifications to the client applications and to the business applications connected to the central server.

28. The architecture of claim 27, wherein the push server is a portion of the central server, as an internal solution.

29. The architecture of claim 27, wherein the push server is a third-party server, as an external solution.

30. The architecture of claim 20, wherein the client application, once in the on state, performs the following steps of:
checking the network to ensure an Internet connection is available;
detecting a GPS position of the customer, in particular of the client user equipment; and
sending the GPS position and other information relating to the area around this position that could be displayed along with business transaction criteria for a business query as provided by the customer to the central server through the client application.

31. The architecture of claim 30, wherein the client application allows a search for suppliers nearby or in remote areas, with or without the help of keywords.

32. The architecture of claim 30, wherein the client user equipment is provided by the central server, on the basis of the received information from the client application, with a result of the business query comprising the suppliers meeting the business query criteria.

33. The architecture of claim 32, wherein the central server activates a map tool in order to get map information of the selected area around the customer position.

34. The architecture of claim 33, wherein the server software of the central server determines the suppliers having downloaded and installed business applications on their business user equipments as well as other suppliers in the area which have not downloaded and installed the business application and generates a result, in the form of a data for each supplier in the selected area, the data including at least the name, number and position of the supplier, such a result being provided to the client application.

35. The architecture of claim 33, wherein the result of the business query is shown in the client user equipment in the form of a map with a plurality of pins, each corresponding to a supplier as found in the selected area.

36. The architecture of claim 35, wherein the pins are different for different types of suppliers.

37. The architecture of claim 36, wherein the pins are different for different types of suppliers according to the following groups:
suppliers with the business application;
suppliers without the business application;
suppliers with the business application and accepting real-time booking;
suppliers with active promotions, according to the promotions data list of the central server; and
suppliers with active coupon-based promotions, according to the coupons data list of the central server.

38. The architecture of claim 36, wherein different pins have different colors and/or shape and/or size.

39. The architecture of claim 33, wherein the client application comprises a default page in turn comprising
a menu portion including icons tied to the different commands of the client application; and
a displaying portion showing the result of the business query

40. The architecture of claim 39, wherein the displaying portion includes a map being centered around the current customer position as provided to the client application, the map being provided by a map tool of the central server and comprising a plurality of pins, each corresponding to a result of the business query made by the customer and being associated to a data strip of the corresponding supplier comprising at least an access button.

41. The architecture of claim 39, wherein the client application further comprises a query page being displayed on the client user equipment.

42. The architecture of claim 39, wherein the query page comprises:
a menu portion, including icons tied to the different commands of the client application;
a selection portion including a plurality of search fields for establishing a search to be made; and
a command portion including at least a confirmation button for determining the showing of the search result.

43. The architecture of claim 42, wherein the search fields comprises list-based search fields able to set different locations or types of suppliers and filter criteria search fields able to specific filtering criteria to be applied to the search.

44. The architecture of claim 42, wherein the search result is displayed in the form of a map with a plurality of pins being different for different suppliers.

45. The architecture of claim 39, wherein the client application further comprises an informational page in turn comprising:
a menu portion, including icons tied to the different commands of the client application;
a view-only informational portion including different data relating to the chosen supplier; and
a selectable informational portion comprising at least one selectable field comprising a data of the chosen supplier which is directly usable by the client user equipment.

46. The architecture of claim 45, wherein the informational page further comprises a promotional portion, being tied to a promotion and/or a coupon offered by the supplier, in turn including an informational textual portion and a multimedia portion.

47. The architecture of claim 46, wherein the informational page further comprises a confirmation button which allows the customer to pick up the promotion or the coupon as offered.

48. The architecture of claim 39, wherein the client application further comprises a booking page allowing for a real-time business transaction with a supplier having the business application and comprising:
a menu portion, including icons tied to the different commands of the client application;
an informational portion, including different data relating to the chosen supplier; and
a selection portion including a plurality of data fields wherein the data relating to the business transaction are inserted.

49. The architecture of claim 48, wherein the booking page further comprises a confirmation button which allows the customer to perform a real-time business transaction.

50. The architecture of claim 48, wherein the data fields of the selection portion are associate to pre-defined data fields that the customer could scroll in order to choose the required data and a confirmation button is provided in the menu portion of the booking page in order to allow the customer to confirm the selected combination of the sliding portions of the scrollable pre-defined data field.

51. The architecture of claim 20, wherein the business application comprises a push page as a default page in turn comprising:
a menu portion including icons tied to the different commands of the business application; and
a business transaction list of a plurality of business transaction requests, each provided with a respective access button.

52. The architecture of claim 51, wherein the transaction list comprises the essential data provided by the customer through the client application.

53. The architecture of claim 51, wherein the business application further comprises a booking confirmation page in turn comprising:
a menu portion, including icons tied to the different commands of the business application;
an informational portion, including the essential data provided by the customer through the client application; and
a command portion, including a plurality of command buttons, in particular an accept button, a deny button and a new proposal button which allows a supplier to accept, deny, or propose new options to the customer.

54. The architecture of claim 53, wherein, when the business transaction is accepted, by clicking on the accept button of the command portion of the booking confirmation page, the business application stores the business transaction and sends a confirmation message to the central server, which stores the accepted business transaction and notifies the customer with a push notification along with a confirmation number to the client application, the client application having the information about the accepted business transaction stored in a booking list.

55. The architecture of claim 53, wherein, when the business transaction is denied, by clicking on the deny button of the command portion of the booking confirmation page, the business application sends a deny message to the central server, which notifies the customer with a push notification, the client application having the information about the denied business transaction stored in a booking list.

56. The architecture of claim 53, wherein, when the supplier wants to change the required business transaction, by clicking on the new proposal button of the command portion of the booking confirmation page, the modified business transaction information as proposed is pushed to the central server, which sends it to the client application.

57. The architecture of claim 56, wherein the customer may choose, within a pre-defined delay to either accept or discard the new business transaction and, if the customer accepts the received business transaction as modified, the central server stores the accepted modified business transaction and notifies the customer with a push notification which also sends a confirmation number to the client application, the accepted modified business transaction being stored in a booking list, while, if the customer denies the received business transaction as modified, the central server notifies the supplier about such denial with a push notification to the business application.

58. The architecture of claim 51, wherein the business application allows a supplier to publish promotions with coupons by using the business user equipment and comprises a coupon page, in turn comprising:
a menu portion, including icons tied to the different commands of the business application;
a data portion, including plurality of fields to be filled in with the essential data relating to the coupon being offered by the supplier, thus allowing a supplier to prepare a promotion with coupons, by describing such a promotion with multimedia content and a number of coupons tied to it, all the information being directly inserted by using the business user equipment; and
a command portion, including includes a plurality of command buttons comprising at least a publish button and a de-activate button which allows a supplier to publish a promotion with coupons and to stop it.

59. The architecture of claim 58, wherein the data portion comprises a at least a title field, a start date field, a stop date field, a text field as well as a coupon number field.

60. The architecture of claim 58, wherein the coupon page further comprises an uploading button, which allows the supplier to add a picture to the coupon.

61. The architecture of claim 58, wherein the coupon page further comprises an informational portion, showing the cost of the promotion with coupons and the available credits of the supplier, the information relating the available credits of each supplier being stored in the central server.

62. The architecture of claim 51, wherein the business application allows a supplier to publish a promotion by using the business user equipment and comprises an add promotion page in turn comprising:
a menu portion, including icons tied to the different commands of the business application;
a data portion, including a plurality of fields to be filled in with the essential data relating to the promotion being offered by the supplier, thus allowing a supplier to prepare a promotion, by describing it with multimedia content, all the information being directly inserted by using the business user equipment; and
a command portion, including a plurality of command buttons comprising at least a publish button and a de-activate button which allows a supplier to publish the promotion and to stop it.

63. The architecture of claim 62, wherein the data portion comprises a at least a title field, a start date field, a stop date field and a text field.

64. The architecture of claim 62, wherein the add promotion page further comprises an uploading portion, which allows the supplier to add pictures to the promotion.

65. The architecture of claim 62, wherein the add promotion page further comprises an informational portion, showing the cost of the promotion and the available credits of the supplier, the information relating the available credits of each supplier being stored in the central server.

66. The architecture of claim 51, wherein the business application further comprises a buy credits page in turn comprising:
a menu portion, including icons tied to the different commands of the business application;
an informational portion, including plurality of fields relating to the credits situation of the supplier; and
a command portion including at least a command button allowing the supplier to buy new credits by means of a payment tool.

67. The architecture of claim 66, wherein the informational portion comprises an available credits field, showing the credits amount still available for the supplier and an offer field, showing the prices of new credits to be bought.

68. The architecture of claim 67, wherein the credits amount shown in the available credits field is updated each time a supplier purchases credits via the buy credits page of the business application and each time a supplier publishes a promotion, with or without coupons, the new credits amount being also sent to the business application.
